(19) United States
(12) Patent Application Publication
(10) Pub. No.: US 2012/0075704 A1
(43) Pub. Date: Mar. 29, 2012

(54) DIFFRACTION OPTICAL ELEMENT

(75) Inventors: Takamasa Ando, Osaka (JP); Tsuguhiro Korenaga, Osaka (JP)

(73) Assignee: PANASONIC CORPORATION, Osaka (JP)

(21) Appl. No.: 13/376,369

(22) PCT Filed: Jun. 4, 2010
(86) PCT No.: PCT/JP2010/003760

§ 371 Date: Dec. 5, 2011

(30) Foreign Application Priority Data
Jun. 11, 2009 (JP) 2009-140478

(51) Int. Cl. G02B 5/18

(52) U.S. Cl. 359/574

(57) ABSTRACT

An imaging optical system according to the present invention includes a lens that has first and second surfaces and that has a diffraction grating on only one of the first and second surfaces. If the diameter of an effective area, which is defined by a light ray that has entered the lens with a maximum angle of view, is D when measured on the surface with the diffraction grating, an F number of the imaging optical system at the maximum angle of view is Fno, a d-line Abbe number of the lens is νd, and an F number of an axial bundle of rays is F, then the average diffracting ring zone pitch [symbol] of the effective area satisfies

$$0.008 \leq \frac{Λ}{D \times Fno} \leq 0.00031 \cdot vd \cdot F$$

### TECHNICAL FIELD

The present invention relates to an arrangement for an imaging optical system that is specially designed so as to reduce a Fraunhofer diffraction image to be produced by an imaging optical system including a diffraction grating.

### BACKGROUND ART

It is already well known in the art that a diffraction grating lens, of which the surface is made up of concentric diffracting ring zones, can correct various lens aberrations such as field curvature and chromatic aberration (which is a shift of a focal point according to the wavelength) very well. This is because a diffraction grating has distinct properties, including inverse dispersion and anomalous dispersion, and also has excellent ability to correct the chromatic aberration. If a diffraction grating is used in an imaging optical system, the same performance is realized by using a smaller number of lenses compared to a situation where an imaging optical system is made up of only aspheric lenses. As a result, the manufacturing cost can be cut down, the optical length can be shortened, and an image capture device including such an imaging optical system can be downsized. In addition to these advantages, if the diffraction grating has either a blazed cross section or fine steps that are inscribed in a blazed shape, the diffraction efficiency of a particular order can be raised to almost 100% with respect to a light ray with a single wavelength.

In theory, the depth of a diffraction grating (which is sometimes called a “blazed thickness”), at which the diffraction efficiency of a first-order diffracted light ray (which will be referred to herein as “first-order diffraction efficiency”) becomes 100%, is given by the following Equation (1):

$$d = \frac{λ}{\vert n ( λ ) - 1 \vert} \qquad ( 1 )$$

where λ is the wavelength, d is the depth of the diffraction grating, and n (λ) is the refractive index of the material of the diffraction grating lens and a function of the wavelength.

According to this Equation (1), as the wavelength λ varies, the d value at which the diffraction efficiency becomes 100% also varies. That is to say, if the d value is fixed, the diffraction efficiency does not become 100% unless the wavelength λ satisfies Equation (1). If a diffractive lens is used for general image capturing purposes, light falling within a broad wavelength range (e.g., a visible radiation wavelength range of 400 nm to 700 nm) needs to be diffracted. For that reason, when a light ray is incident on a diffractive lens, which has a diffraction grating 12 on a lens body 11, not only a first-order diffracted light ray 201 but also other diffracted light rays 202 of unnecessary orders (which will be sometimes referred to herein as “unnecessary order diffracted light rays”) are produced on an image capturing plane 31 as shown in FIG. 18, thus deteriorating the image quality with flares or ghosts or degrading the MTF (modulation transfer function) characteristic.

However, the generation of such unnecessary order diffracted light rays 202 can be reduced significantly by either covering the surface with the diffraction grating 12 with a protective coating 211 of an optical material that has a different refractive index and a different refractive index dispersion from the material of the lens body 11 or bonding such a coating to the surface as shown in FIG. 19. Patent Document No. 1 discloses an example in which by setting the refractive index of the material of the body with the diffraction grating and that of the protective coating 211 that covers the diffraction grating to fall within particular ranges, the wavelength dependence of the diffraction efficiency is reduced. As a result, the flares involved with the unnecessary order diffracted light rays 202 such as the one shown in FIG. 18 can be eliminated.

Another method is disclosed in Patent Document No. 2, in which when an image is shot with a camera that uses an ordinary diffraction grating lens such as the one shown in FIG. 18, the absolute quantity of the unnecessary order diffracted light rays 202 is calculated by making fitting on the two-dimensional point image distribution of the unnecessary order diffracted light rays 202 by the minimum square method, thereby removing the unnecessary order diffracted light rays 202. Still another method is disclosed in Patent Document No. 3, in which if there are any saturated pixels when the first picture is shot, the second picture is shot so that those pixels do not get saturated and in which the absolute quantity of the unnecessary order diffracted light rays 202 is calculated based on the adjusted value of the exposure process time when the second picture is shot, thereby removing the unnecessary order diffracted light rays 202.

### CITATION LIST

### Patent Literature

Patent Document No. 1: Japanese Patent Application Laid-Open Publication No. 09-127321
Patent Document No. 2: Japanese Patent Application Laid-Open Publication No. 2005-167485
Patent Document No. 3: Japanese Patent Application Laid-Open Publication No. 2000-333076

### SUMMARY OF INVENTION

### Technical Problem

The present inventors discovered that as the pitch of diffracting ring zones on the surface with the diffraction grating was reduced, fringed flare light rays, having a different pattern from the unnecessary order diffracted light rays 202 shown in FIG. 18, would be produced. Such flare light rays are generally illustrated in FIG. 20. Parts of the main first-order diffracted light ray become fringed flare light rays 221, which appear in a fringed pattern in the vicinity of the intended focal point. Such fringed flare light rays 221 are sensible more easily when an even larger quantity of light than the incident light that produces the unnecessary order diffracted light rays 202 shown in FIG. 18 enters the imaging optical system. Those fringed flare light rays 221 spread more broadly on the image than the unnecessary order diffracted light rays 202, thus deteriorating the image quality. Particularly in an unusual shooting environment with an extremely high contrast ratio (e.g., when a bright subject such as a light needs to be shot on a totally dark background at night, for example), the fringed flare light rays 221 would get even more noticeable and cause a problem.

It is therefore an object of the present invention to provide an imaging optical system with a diffraction grating that can reduce generation of such fringed flare light rays.

### Solution to Problem

An imaging optical system according to the present invention includes a lens that has first and second surfaces and that has a diffraction grating on only one of the first and second surfaces. If the diameter of an effective area, which is defined by a light ray that has entered the lens with a maximum angle of view, is D when measured on the surface with the diffraction grating, an F number of the imaging optical system at the maximum angle of view is Fno, a d-line Abbe number of the lens is νd, and an F number of an axial bundle of rays is F, then the average diffracting ring zone pitch [symbol] of the effective area satisfies

$$0.008 \leq \frac{Λ}{D \times Fno} \leq 0.00031 \cdot vd \cdot F$$

In one preferred embodiment, the average diffracting ring zone pitch [symbol] satisfies

$$0.01 \leq \frac{Λ}{D \times Fno} \leq 0.00021 \cdot vd \cdot F$$

In this particular preferred embodiment, the order of diffraction of the diffraction grating is second-order or a higher order.

In a specific preferred embodiment, the imaging optical system further includes an optical adjustment layer, which has been formed on the surface with the diffraction grating and which satisfies

$$\frac{0.9 m λ}{\vert {n}_{1} ( λ ) - {n}_{2} ( λ ) \vert} \leq d \leq \frac{1.1 m λ}{\vert {n}_{1} ( λ ) - {n}_{2} ( λ ) \vert}$$

where d is the depth of the diffraction grating, m is the order of diffraction, λ is the wavelength, n₁ (λ) is the refractive index of the lens, and n₂ (λ) is the refractive index of the optical adjustment layer.

In a more specific preferred embodiment, if a light ray passes with a full angle of view through an area on the surface of the lens with the diffraction grating, the diffraction grating covers only a part of that area and does not cover the other part of that area.

In an even more specific preferred embodiment, if a light ray passes with the full angle of view through the area on the surface of the lens with the diffraction grating, the diffraction grating covers only a part of that area that is located closer to the optical axis of the lens than a predetermined radial location is, and does not cover the other part of that area that is more distant from the optical axis than the predetermined radial location is.

### Advantageous Effects of Invention

According to the present invention, even when an intense light source needs to be shot, an image with little fringed flare light can be obtained. In addition, the magnitude of the axial chromatic aberration can be reduced to a negligible level.

### BRIEF DESCRIPTION OF DRAWINGS

FIG. 1 shows a cross-sectional view and a plan view illustrating a preferred embodiment of an imaging optical system according to the present invention.

FIG. 2 illustrates ring zones of a diffraction grating as viewed in the optical axis direction.

FIG. 3 illustrates how a bundle of rays that has passed through a diffracting ring zone 21 is condensed onto an image sensor 31 and produces fringed flares there.

FIG. 4 shows the exit pupil diameter 41 of an area to be evaluated and the distance 42 from the exit pupil to an imaging point.

FIG. 5(a) is a graph showing how high the diffraction efficiency achieved by an imaging optical system with no optical adjustment layer would be when a first-order diffracted light ray or a second-order diffracted light ray was used. FIG. 5(b) is a graph showing how high the diffraction efficiency achieved would be when an optical adjusting layer was provided for the system.

FIG. 6(a) is a graph showing how much the diffraction efficiency depends on the wavelength in a situation where the material of the lens body has a refractive index of 1.585 and an Abbe number of 27.9 with respect to a d line, the optical adjustment layer has a refractive index of 1.623 and an Abbe number of 40 with respect to a d line, m==1 (which means a first-order diffracted light ray is used) and the coefficient is set to be 0.9, 1 or 1.1. FIG. 6(b) is a graph showing the wavelength dependence of the diffraction efficiency in a situation where the same materials are used as in FIG. 6(a) but the coefficient is set to be 0.8 or 1.2.

FIG. 7(a) is a graph showing the wavelength dependence of the diffraction efficiency in a situation where the same materials are used as in FIG. 6(a) but m==2. FIG. 7(b) is a graph showing the wavelength dependence of the diffraction efficiency in a situation where the same materials are used as in FIG. 7(a) but the coefficient is set to be 0.8 or 1.2.

FIG. 8 illustrates a cross-sectional shape of a lens surface on which only a part of the effective area is covered with a diffraction grating.

FIGS. 9(a) and 9(b) are respectively a cross-sectional view and a plan view illustrating another preferred embodiment of an imaging optical system according to the present invention. FIGS. 9(c) and 9(d) are respectively a cross-sectional view and a plan view illustrating still another preferred embodiment of an imaging optical system according to the present invention.

FIG. 10 is a cross-sectional view illustrating yet another preferred embodiment of an imaging optical system according to the present invention.

FIG. 11 is a cross-sectional view illustrating a specific example of an imaging optical system according to the present invention.

FIG. 12(a) shows a two-dimensional image that was produced on a focal plane when a planar wave with a wavelength of 550 nm was incident on an imaging optical system representing a specific example of the present invention from a direction with the maximum angle of view. FIG. 12(b) shows a two-dimensional image that was produced on a focal plane when a planar wave with a wavelength of 550 nm was incident on an imaging optical system representing a comparative example from a direction with the maximum angle of view.

FIG. 13 is a graph showing how the quantity of fringed flares produced changes with the diffracting ring zone pitch [symbol] .

FIG. 14 is a graph showing how the magnitude of chromatic aberration changed in the imaging optical system of this specific example of the present invention when the diffracting ring zone pitch was adjusted by changing the phase polynomial of the diffraction grating.

FIG. 15 illustrates the depth of focus 113 and permissible circle of confusion 112 of a lens 111.

FIG. 16 is a cross-sectional view illustrating a diffraction grating lens in a situation where a second-order diffracted light ray is used.

FIG. 17 is a graph showing how the intensity of a fringed flare portion per pixel changes with the value of the conditional equation [symbol] /(D×Fno).

FIG. 18 illustrates how unnecessary order diffracted light rays are produced in a conventional diffraction grating lens.

FIG. 19 is a cross-sectional view illustrating a conventional diffraction grating lens with an additional protective coating.

FIG. 20 illustrates how fringed flares are produced.

### DESCRIPTION OF EMBODIMENTS

Hereinafter, a preferred embodiment of an imaging optical system according to the present invention will be described with reference to FIG. 1. The imaging optical system of this preferred embodiment includes a lens 10, which includes a lens body 11 that has first and second surfaces 11a and 11b and a diffraction grating 12 that has been formed on the second surface 11b. The diffraction grating 12 is made up of a number of ring zones, which are arranged concentrically on the second surface 11b with respect to the optical axis 13 as the center.

Although the imaging optical system shown in FIG. 1 includes only one lens 10, the imaging optical system may include multiple lenses as well. Also, the first and second surfaces 11a and 11b of the lens 10 may be either spherical or aspheric ones. Furthermore, in a situation where the imaging optical system has multiple lenses, the lens 10 with the diffraction grating 12 may be any of those multiple lenses. And there may be multiple lenses 10 with the diffraction grating. Moreover, it does not matter whether the second surface 11b with the diffraction grating 12 faces the subject or the image capture device.

Nevertheless, it is still preferred that the diffraction grating 12 be provided for only one of the first and second surfaces 11a and 11b of the lens body 11 of each lens 10. This is because if the diffraction grating 12 were provided for both of the first and second surfaces 11a and 11b, unnecessary order diffracted light rays would be produced on each of those two surfaces and the overall diffraction efficiency of the lens 10 would decrease easily. However, by providing the diffraction grating 12 for only one side of the lens body 11, the optical loss of the diffracted light of the desired order can be minimized and the flare light to be produced by those unnecessary order diffracted light rays can be reduced significantly.

The ring zones of the diffraction grating 12 do not always have to be arranged concentrically around the optical axis 13. Nonetheless, in order to improve the aberration property of an optical system for use to capture an image, it is still preferred that the ring zones of the diffraction grating 12 be rotationally symmetric with respect to the optical axis 13.

If the diffraction grating 12 is designed so that more distant from the optical axis 13, the smaller the diffracting ring zone pitch gets, even the aberration caused by an obliquely incident light ray can also be corrected as intended. Meanwhile, as the diffracting ring zone pitch decreases, the quantity of the fringed flare light rays 221 shown in FIG. 20 increases. Among other things, at the maximum angle of view at which the diffracting ring zone pitch becomes the smallest, those fringed flare light rays 221 are produced particularly significantly. In this case, the “maximum angle of view” refers to the largest angle of incidence at which an incoming light ray can enter a lens, and is defined by the diaphragm or the edge of a lens. The imaging optical system of this preferred embodiment includes such a diaphragm 43. Speaking more strictly, the maximum angle of view refers to the angle of view of a bundle of rays that has the maximum image height on an image capturing plane. For example, if a rectangular image sensor is used, it is a bundle of rays condensed at a diagonal end of the effective area of the image sensor that has the maximum angle of view. On the other hand, according to a shooting method in which the effective area is not used fully (e.g., when a fish-eye lens that outputs a circular image is used), it is a bundle of rays condensed at the maximum location of the circular image captured (i.e., the maximum effective image circle diameter) that has the maximum angle of view.

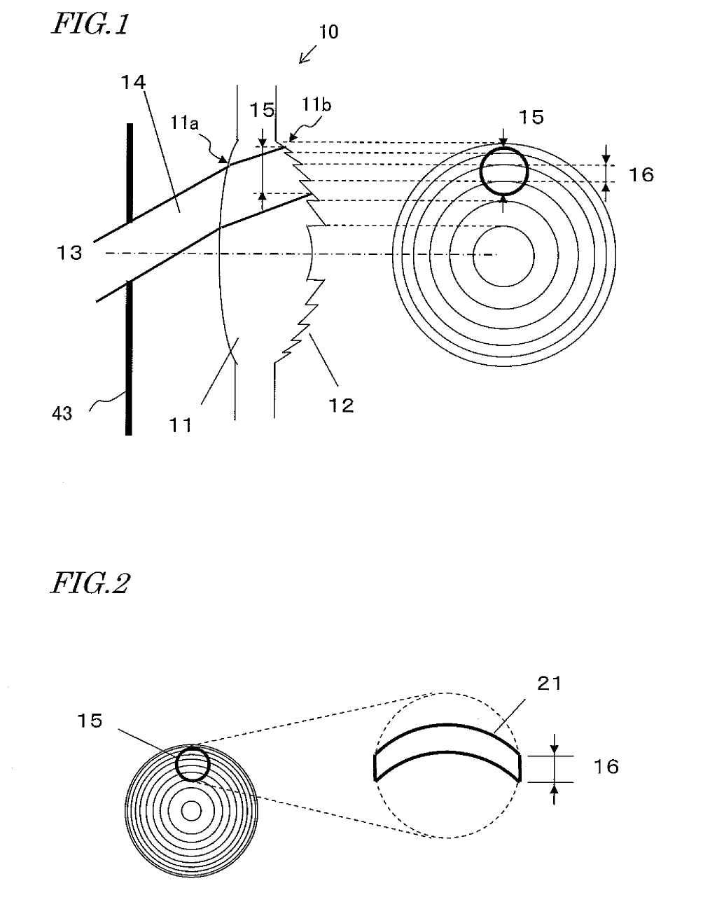

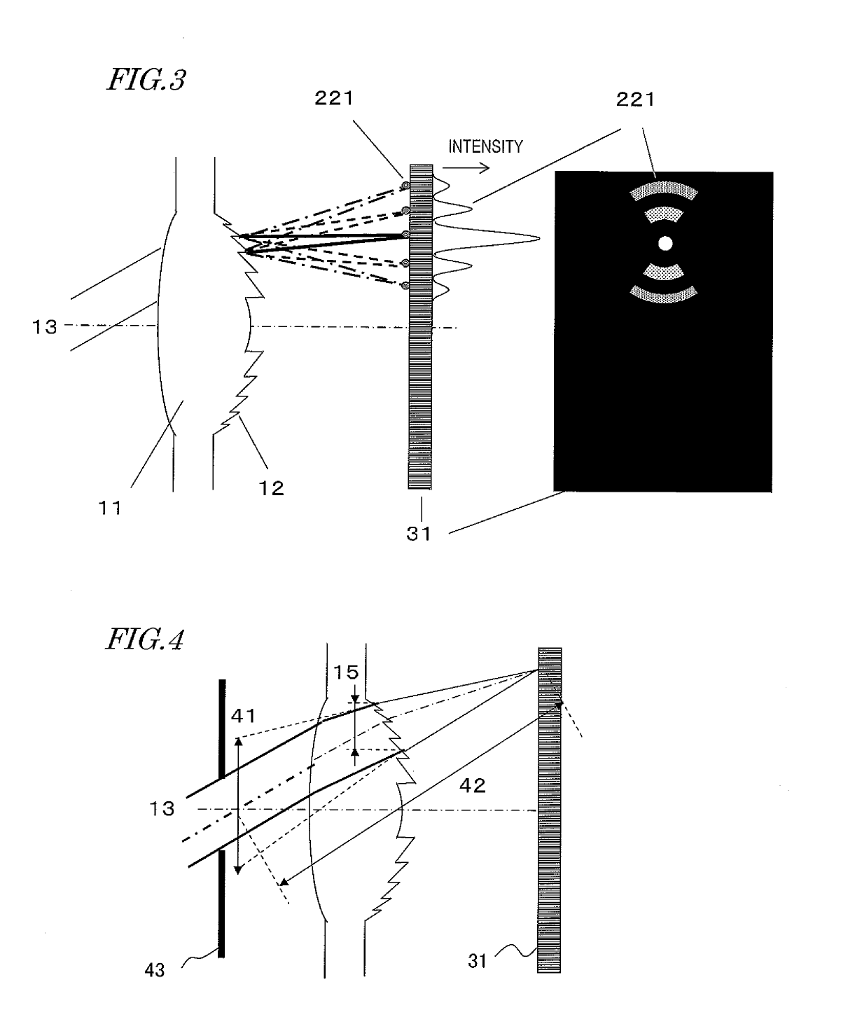

If an obliquely incident light 14 with the maximum angle of view enters the imaging optical system, an effective area 15 is formed on a plane of the diffraction grating 12. Suppose the diameter of the effective area 15 as measured in the lens radial direction is D and the average diffracting ring zone 16 in the effective area 15 is [symbol] . In this case, the “average diffracting ring zone pitch 16” refers herein to the average of the pitch widths of all diffracting ring zones that are included in the effective area 15. If attention is paid to one diffracting ring zone 21 in the effective area 15, the bundle of rays should pass through a very narrow gap between opaque diffraction steps to go through that zone as shown in FIG. 2. The reason is that as the wavefront of the light is cut off between two adjacent diffracting zing zones, the effect produced would be as if the light passed through a very narrow slit. In the vicinity of the diffraction steps, the wavefront is seen to bypass. FIG. 3 illustrates how a bundle of rays that has passed through the diffracting ring zone 21 is condensed onto the image sensor 31.

Generally speaking, a light ray that has passed through a very narrow slit will form diffraction fringes at a viewpoint at infinity, which is so-called “Fraunhofer diffraction”. If a lens system with a positive focal length is included, such a diffraction phenomenon also arises at a finite distance (i.e., on a focal plane). In a diffraction grating lens that has multiple diffraction ring zones in the effective area 15, each of those diffraction ring zones 21 produces such diffraction fringes due to the Fraunhofer diffraction. The present inventors confirmed via experiments that the diffraction ring zones 21 with the shape shown in FIG. 2 produced butterfly shaped fringed flares as shown in FIG. 3, in which the fringed flares produced look like a butterfly with unfolded wings.

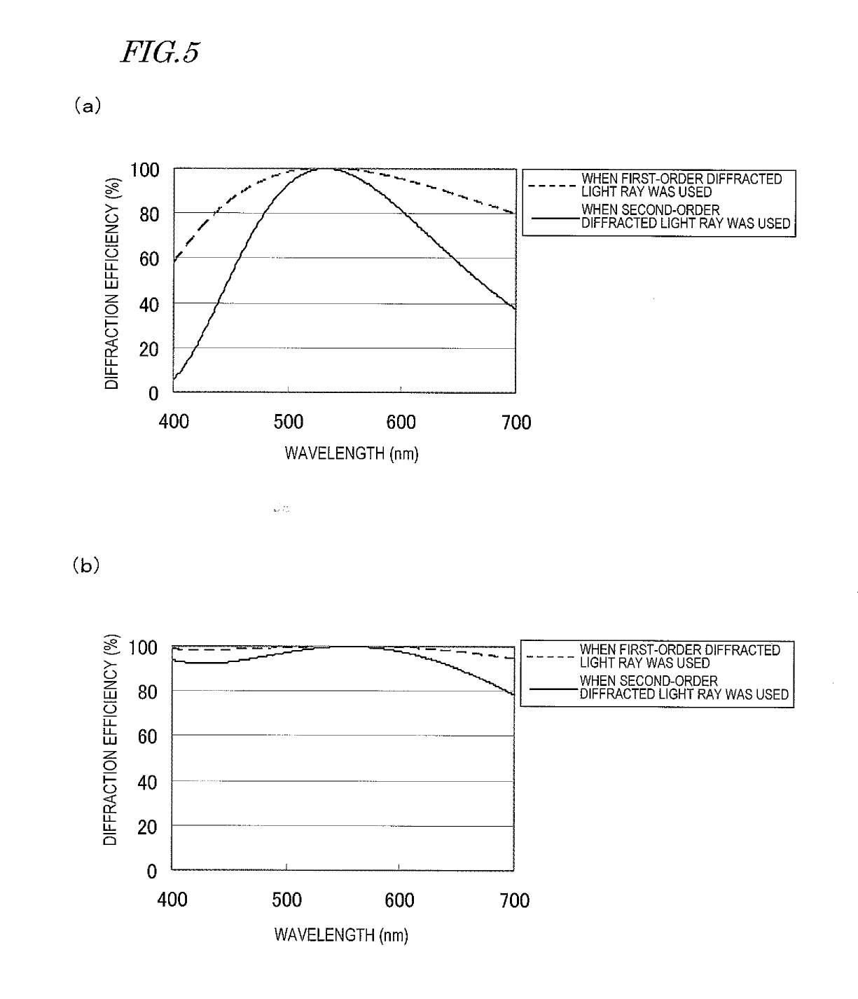

The higher the ratio of the sum of the lengths of all opaque edges to the area of the aperture through which a bundle of rays passes, the greater the quantity (i.e., integrated quantity of light rays) of the diffraction fringes produced due to the Fraunhofer diffraction. Also, the more distant the imaging point is, the greater the quantity of the diffraction fringes produced due to the Fraunhofer diffraction. For that reason, supposing the number of ring zones in the effective area 15 is N, the exit pupil diameter is L, and the distance 42 from the exit pupil to the imaging point is f as shown in FIG. 4, the following relation (2) is satisfied:

(integrated quantity of light rays with diffraction fringes)∞N/L·f (2)

In this case, the number N of the ring zones is represented by the following Equation (3) using the diameter D of the effective area 15 and the average diffraction ring zone pitch [symbol] in the effective area 15:

$$N = \frac{D}{Λ} \qquad ( 3 )$$

Also, if the F number at the maximum angle of view is represented by Fno, then Fno satisfies the following Equation (4):

$$Fno = \frac{f}{L} \qquad ( 4 )$$

That is why by substituting Equations (3) and (4) into the Relation (2), the following Equation (5) is derived:

[symbol]

=C·((D·Fno)/integrated quantity of light rays with diffraction fringes) (5)

where C is a constant of proportionality. Equation (5) indicates that the integrated quantity of light rays with diffraction fringes is inversely proportional to the average diffracting ring zone pitch [symbol] . Consequently, it can be seen from this Equation (5) that the greater the average diffracting ring zone pitch [symbol] , the more significantly the integrated quantity of light rays with diffraction fringes can be reduced.

However, if the ring zone pitch Λ was too large, then the power of diffraction would be too low to correct the chromatic aberration sufficiently. For that reason, to make the diffraction grating correct the chromatic aberration sufficiently and to establish a good imaging optical system that has a small integrated quantity of light rays with diffraction fringes, the average ring zone pitch [symbol] of the diffraction grating is set so as to satisfy the following Inequality (6) for the reasons to be described later:

$$0.008 \leq \frac{Λ}{D \times Fno} \leq 0.00031 \cdot vd \cdot F \qquad ( 6 )$$

where νd is a d-line Abbe number of the material of the lens body with the diffraction grating and F is an F number of the axial bundle of rays.

To achieve even more significant effects, the following Inequality (7) is preferably satisfied for the reasons to be described later:

$$0.01 \leq \frac{Λ}{D \times Fno} \leq 0.00021 \cdot vd \cdot F \qquad ( 7 )$$

A bundle of rays that has entered the imaging optical system at an angle of view of 0 degrees forms an effective area, which is rotationally symmetric with respect to the optical axis, on the surface with the diffraction grating. In this case, a center portion of the diffraction grating with relatively large diffracting ring zone pitches accounts for the majority of the effective area. Consequently, the average diffracting ring zone pitch increases and the quantity of the light rays with the fringed flares decreases. On the other hand, if the angle of view of the incident light rays increases, the average diffracting ring zone pitch [symbol] of the diffraction grating decreases and the quantity of the fringed flare light rays 221 produced increases. And the greater the angle of incidence of light on the surface with the diffraction grating, the smaller the apparent pitch width. For these reasons, it is particularly effective if the present invention is applied to an imaging optical system with a half angle of view of 15 degrees or more, which is apt to produce a lot of fringed flare light rays 221.

The number of ring zones in a diffraction grating has something to do with the magnitude of chromatic aberration correction to make. That is to say, by setting the number of ring zones within an appropriate range, the magnitude of the chromatic aberration to be produced by the imaging optical system can be kept appropriate. If the given imaging optical system is intended to be used in either a single color application or an application that does not pay much attention to chromatic aberration correction, there is no problem as long as the imaging optical system is designed so as to satisfy the Inequalities (6) and (7). However, in order to reduce the quantity of the fringed flare light rays 221 produced with the optimum chromatic aberration correction made continuously, it is preferred that the diffraction grating be designed so as to use a second-order diffracted light ray or an even higher order of diffracted light ray. To use the second order of diffraction, the depth of the diffraction grating needs to be doubled compared to the first-order one. And to use the third order of diffraction, the depth of the diffraction grating needs to be tripled compared to the first-order one. In this case, the diffracting ring zone pitches also need to be doubled and tripled, respectively, compared to the first-order one and can be broadened compared to a situation where a first-order diffracted light ray is used. As a result, even if the magnitude of the chromatic aberration correction to make is not different from when the first-order diffracted light ray is used, Inequality (6) or (7) can still be satisfied and the fringed flares can also be reduced.

In order to reduce the unnecessary order diffracted light rays 202 in a broad wavelength range, the imaging optical system of this preferred embodiment may further include an optical adjustment layer that covers the diffraction grating 12 of the lens 10.

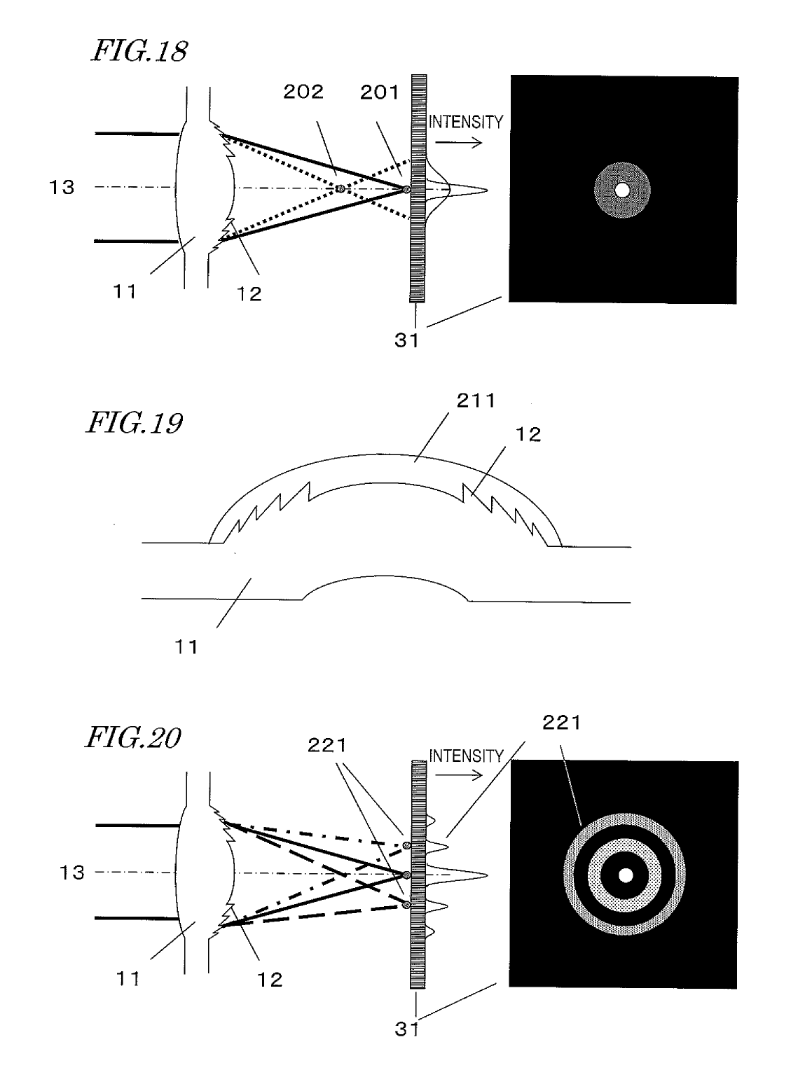

FIG. 5(a) is a graph showing how high the diffraction efficiency achieved by an imaging optical system according to this preferred embodiment, which has no optical adjustment layer, would be when a first-order diffracted light ray or a second-order diffracted light ray was used. Specifically, when the first-order diffracted light ray was used, the diffraction efficiency decreased at a wavelength of 400 nm (representing a blue ray) and at a wavelength of 700 nm (representing a red ray). It can be seen that when a second-order diffracted light ray was used, the diffraction efficiency decreased even more significantly to less than 50%. On the other hand, FIG. 5(b) is a graph showing how high the diffraction efficiency achieved by an imaging optical system according to this preferred embodiment would be when an optical adjusting layer was provided for the system. As can be seen from FIG. 5(b), no matter whether the diffracted light rays used were first-order or second-order, the diffraction efficiency achieved was always high enough. These results reveal that no matter whether the diffracted light rays used are first-order or second-order, the unnecessary diffracted light rays 202 (shown in FIG. 18) can be reduced by providing the optical adjustment layer. Particularly when second-order diffracted light rays are used, the diffraction efficiency achieved is quite different depending on whether the optical adjustment layer is provided for the imaging optical system or not. To reduce the fringed flare light rays 221 (see FIG. 3), it is effective to use a second-order diffracted light ray or light rays of a higher order of diffraction. In that case, by arranging an optical adjustment layer on the surface of a diffraction grating, the unnecessary order diffracted light rays 202 can be reduced particularly effectively. As for the structure of the optical adjustment layer, a film with the same structure as the conventional protective coating shown in FIG. 19 may be used as the optical adjustment layer. And the optical adjustment layer may be made of a resin, glass, or a composite material including a resin and inorganic particles in combination, for example.

When the optical adjustment layer is provided, the best depth of the diffraction grating is represented by the following Equation (8):

$$d = \frac{m λ}{\vert {n}_{1} ( λ ) - {n}_{2} ( λ ) \vert} \qquad ( 8 )$$

where d is the depth of the diffraction grating, m is the order of diffraction, λ is the wavelength, n₁ (λ) is the refractive index of the material of the lens body, on which the diffraction grating has been formed, at the wavelength λ, and n₂ (λ) is the refractive index of the optical adjustment layer at the wavelength λ.

To satisfy this Equation (8), the optical path difference needs to be an integral number of times as long as the wavelength. As a result, high diffraction efficiency can be achieved. Next, it will be described how the diffraction efficiency changes if the optical path difference becomes no longer an integral number of times as long as the wavelength. Such a variation in optical path difference from an integral multiple of the wavelength can be represented by multiplying the right side of Equation (8) by a coefficient. For example, if the right side of Equation (8) is multiplied by a coefficient of 0.9, the optical path difference becomes 90% of the integral multiple of the wavelength.

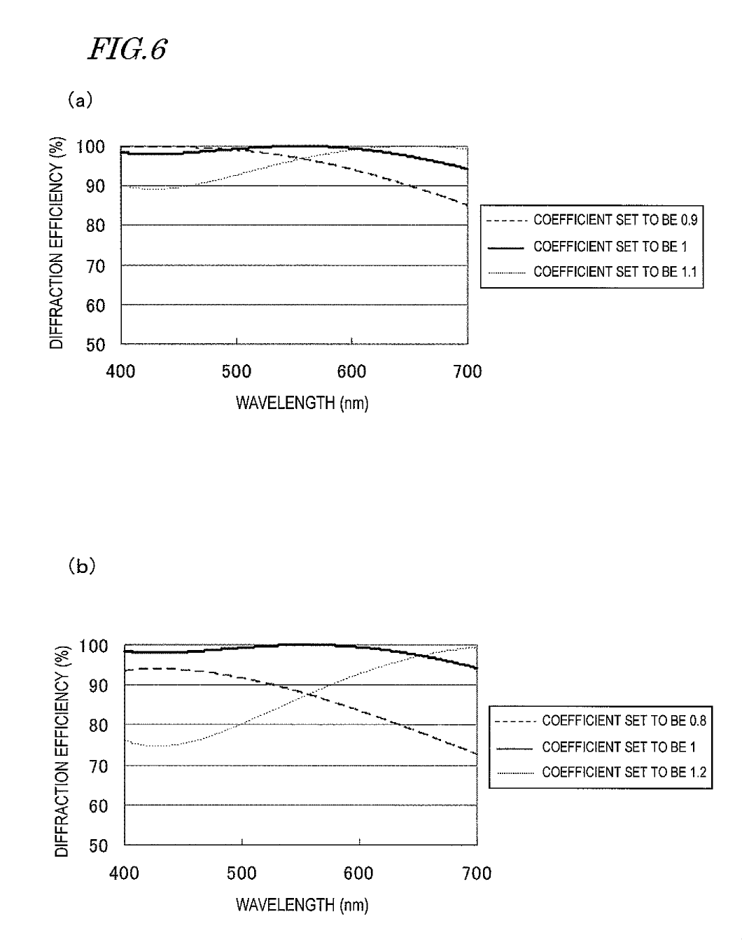

FIG. 6(a) is a graph showing how much the diffraction efficiency depends on the wavelength in a situation where the material of the lens body has a refractive index of 1.585 and an Abbe number of 27.9 with respect to a d line, the optical adjustment layer has a refractive index of 1.623 and an Abbe number of 40 with respect to a d line, m==1 (which means a first-order diffracted light ray is used) and the coefficient is set to be 0.9, 1 or 1.1. On the other hand, FIG. 6(b) is a graph showing the wavelength dependence of the diffraction efficiency in a situation where the same materials are used as in FIG. 6(a) but the coefficient is set to be 0.8, 1 or 1.2. In both of FIGS. 6(a) and 6(b), the diffraction efficiency is seen to decrease around a wavelength of 400 nm (representing a blue ray) and around a wavelength of 700 nm (representing a red ray). Specifically, around a wavelength of 400 nm, the diffraction efficiency is approximately 90% according to the curve associated with coefficient of 1.1 shown in FIG. 6(a) but decreases to 75% according to the curve associated with a coefficient of 1.2 shown in FIG. 6(b). Also, around a wavelength of 700 nm, the diffraction efficiency is approximately 85% according to the curve associated with a coefficient of 0.9 shown in FIG. 6(a) but decreases to almost 70% according to the curve associated with a coefficient of 0.8 shown in FIG. 6(b).

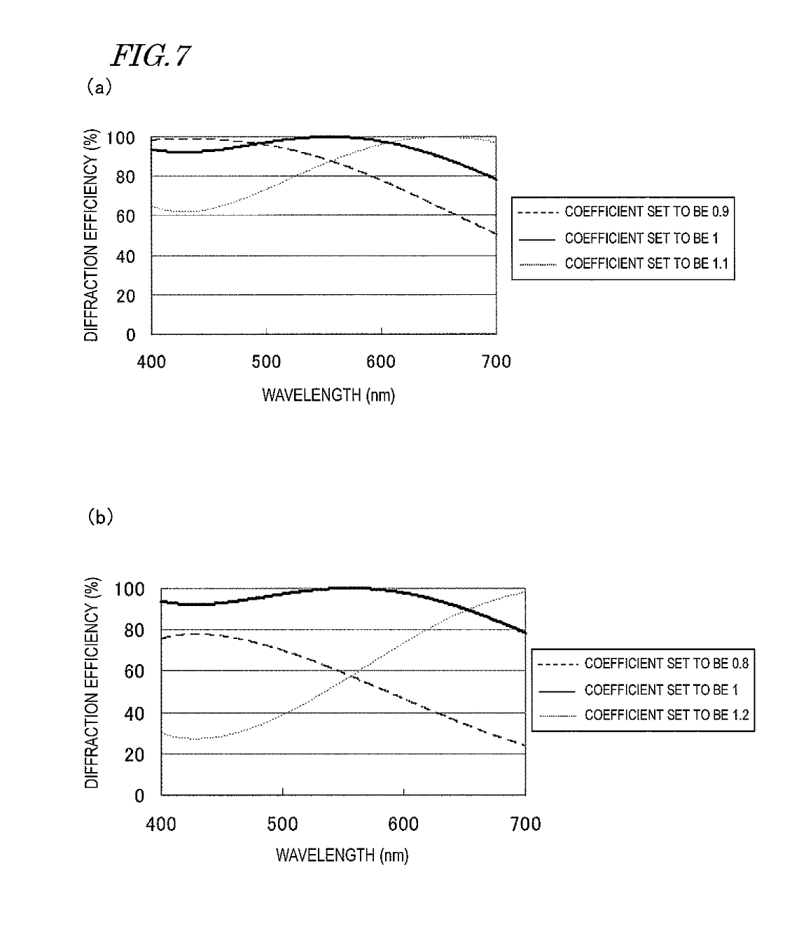

FIG. 7(a) is a graph showing the wavelength dependence of the diffraction efficiency in a situation where the same materials are used as in FIG. 6(a) but m==2 (which means a second-order diffracted light ray is used). On the other hand, FIG. 7(b) is a graph showing the wavelength dependence of the diffraction efficiency in a situation where the same materials are used as in FIG. 7(a) but the coefficient is set to be 0.8 or 1.2. In both of FIGS. 7(a) and 7(b), the diffraction efficiency is seen to decrease around a wavelength of 400 nm (representing a blue ray) and around a wavelength of 700 nm (representing a red ray). Specifically, around a wavelength of 400 nm, the diffraction efficiency is approximately 60% according to the curve associated with a coefficient of 1.1 shown in FIG. 7(a) but decreases to 30% according to the curve associated with a coefficient of 1.2 shown in FIG. 7(b). Also, around a wavelength of 700 nm, the diffraction efficiency is approximately 50% according to the curve associated with a coefficient of 0.9 shown in FIG. 7(a) but decreases to almost 20% according to the curve associated with a coefficient of 0.8 shown in FIG. 7(b). The results shown in FIGS. 6(a), 6(b), 7(a) and 7(b) reveal that no matter whether the light ray used is a first-order diffracted light ray or a second-order diffracted light ray, the decrease in diffraction efficiency can be at least halved (reduced to 50% or less) by setting the coefficient to be within the range of 0.9 to 1.1 and the unnecessary order light rays 202 can be cut down.

In view of these considerations, the optical adjustment layer is preferably formed so as to satisfy the following Inequality (9):

$$\frac{0.9 m λ}{\vert {n}_{1} ( λ ) - {n}_{2} ( λ ) \vert} \leq d \leq \frac{1.1 m λ}{\vert {n}_{1} ( λ ) - {n}_{2} ( λ ) \vert} \qquad ( 9 )$$

where d is the depth of the diffraction grating, m is the order diffraction, λ, is the wavelength, n₁ is the refractive index of the material of the lens body on which the diffraction grating has been formed, and n₂ is the refractive index of the optical adjustment layer. Inequality (9) is preferably satisfied in the entire wavelength range used.

By setting the depth of the diffraction grating so as to be neither less than the lower limit of Inequality (9) nor more than the upper limit of Inequality (9), the wavelength dependence of the diffraction efficiency can be reduced and the unnecessary order diffracted light rays 202 can also be cut down over the entire wavelength range used.

If lens design data such as the aspheric coefficient and the lens surface interval is available in advance, the diameter of the effective area 15 and the maximum angle of view Fno can be obtained by performing ray tracing using a lens design software program. In this case, the maximum angle of view Fno can also be obtained as the inverse number of the cosine difference in the ray direction between the upper- and lower-limit rays that have the maximum angle of view on the image plane. For example, if the maximum angle of view is set in the y direction and if the cosine in the direction of the upper-limit ray on the image plane is represented by (Lu, Mu, Nu) and if the cosine in the direction of the lower-limit ray on the image plane is represented by (Ld, Md, Nd), then the following Equation (10) is satisfied:

$$Fno = \frac{1}{Md - Mu} \qquad ( 10 )$$

On the other hand, if the lens design data is not available, then a collimated parallel beam (which is equivalent to a subject at infinity) may be incident on the imaging optical system under test from the maximum angle of view and the light beam may be focused on the surface with the diffraction grating through an objective lens and monitored. In that case, the range of the effective area 15 is projected by the incoming light onto the surface with the diffraction grating and can be measured in detail. Fno may be measured by adjusting the focal point of the objective lens to the vicinity of the focal point of the imaging optical system under test and by shifting the focal point of the objective lens along the optical axis of the imaging optical system under test from there. In that case, since it is possible to monitor how a light beam spot that has been condensed by the imaging optical system under test is further condensed or spread, measurements can be done by tracing that light beam spot.

Alternatively, the average diffracting ring zone pitch [symbol] may also be reduced by making the diffraction grating cover only a part of the area through which a light ray with the full angle of view passes (i.e., an area within the effective diameter of the lens). For example, as shown in FIG. 8, the diffraction grating 12 may cover only a part of the area 17 on the second surface 11b, through which the light ray with the full angle of view passes, so as to be located in a center portion that is closer to the optical axis 13 than a predetermined radial location r0 is, and may not cover the other part of that area 17, which is located in a peripheral portion that is more distant from the optical axis than the predetermined radial location r0 is. In that case, the peripheral portion may be an aspheric shape portion 12a, which may be obtained just by extending the aspheric shape of the base on which the diffraction grating 12 has not been formed yet. Then, a light ray that passes through the aspheric shape portion 12a becomes a zero-order diffracted light ray. Nevertheless, the aspheric shape does not have to be the original base shape but may be any other appropriate shape for the given imaging optical system. With such an arrangement adopted, the diffraction grating can be eliminated from the peripheral portion where the ring zone pitch tends to be small. As a result, the area where fringed flare light rays are often produced can be reduced effectively, and therefore, an imaging optical system with good performance can be obtained.

According to this preferred embodiment, by setting the value of the conditional equation Λ/(D×Fno) to be 0.008 or more, the generation of the fringed flares can be minimized. On the other hand, by setting the value of the conditional equation Λ/(D×Fno) to be 0.00031·νd·F or less, the magnitude of the axial chromatic aberration can be reduced to an unnoticeable range.

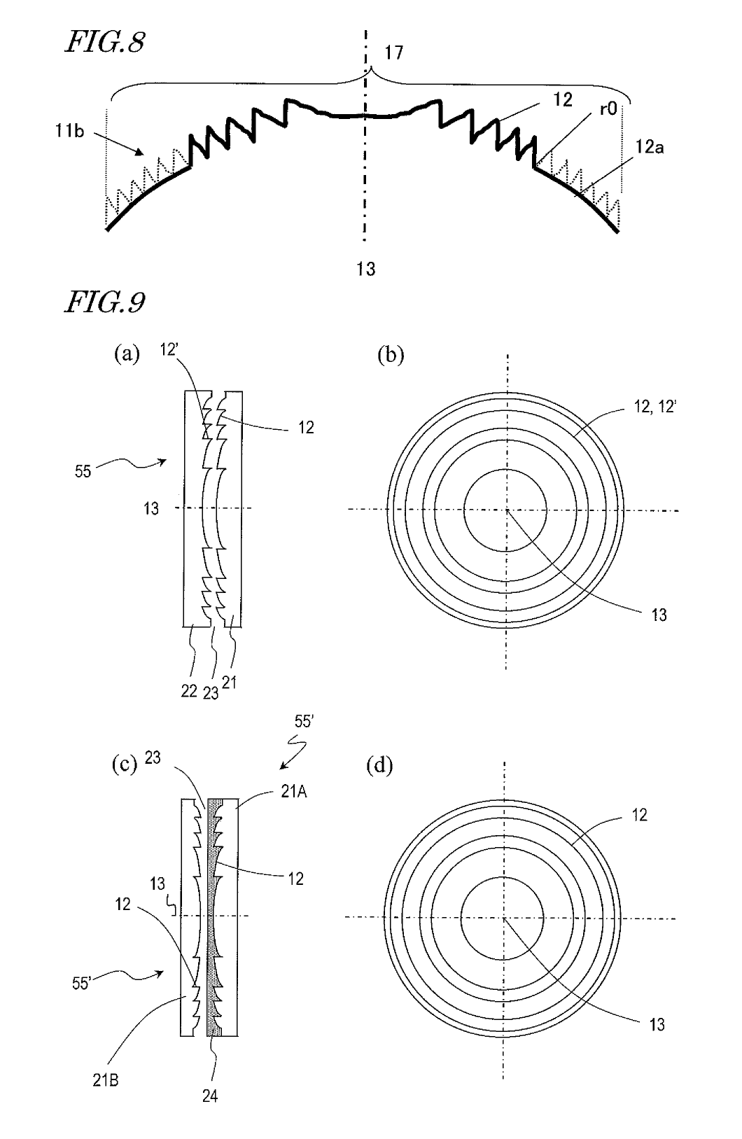

In the preferred embodiment described above, the imaging optical system is supposed to include only one lens with a diffraction grating. However, the imaging optical system may also include two or more such lenses with a diffraction grating. FIGS. 9(a) and 9(b) are respectively a schematic cross-sectional view and a plan view illustrating another preferred embodiment of an imaging optical system according to the present invention. This imaging optical system 55 includes two lenses, each of which has a diffraction grating. Specifically, one of the two lenses includes a body 21 and a diffraction grating 12, which has been formed on one of the two surfaces of the body 21. The other lens includes a body 22 and a diffraction grating 12′, which has been formed on one of the two surfaces of the body 22. These two lenses are held with a predetermined gap 23 left between them. Each of these two lenses satisfies the Inequality (6) and preferably satisfies the Inequality (7), too. These diffraction gratings 12 and 12′ use two different orders of diffraction with mutually opposite signs (i.e., positive and negative) but do use the same phase difference function.

FIGS. 9(c) and 9(d) are respectively a schematic cross-sectional view and a plan view illustrating still another preferred embodiment of an imaging optical system according to the present invention. This optical system 55′ includes two lenses and an optical adjustment layer 24. Specifically, one of the two lenses includes a body 21A and a diffraction grating 12, which has been formed on one of the two surfaces of the body 21A. The other lens includes a body 21B and a diffraction grating 12, which has been formed on one of the two surfaces of the body 21B. The optical adjustment layer 24 covers the diffraction grating 12 of the body 21A. These two lenses are held with a predetermined gap 23 left between the diffraction grating 12 on the surface of the body 21B and the optical adjustment layer 24. The respective diffraction gratings 12 of the two lenses have the same shape. Each of these two lenses satisfies the Inequality (6) and preferably satisfies the Inequality (7), too.

Even these imaging optical systems 55 and 55′, in each of which two lenses are stacked one upon the other, can also minimize the generation of fringed flare light rays and can also achieve good chromatic aberration properties because each lens satisfies the Inequality (6) as described above. Also, in the imaging optical systems 55 and 55′, a pair of lenses, each having a diffraction grating, is arranged close to each other, and the two diffraction gratings have either the same shape or corresponding shapes. As a result, the two diffraction gratings substantially function as a single diffraction grating and contribute to achieving the effects described above without causing a significant decrease in diffraction efficiency.

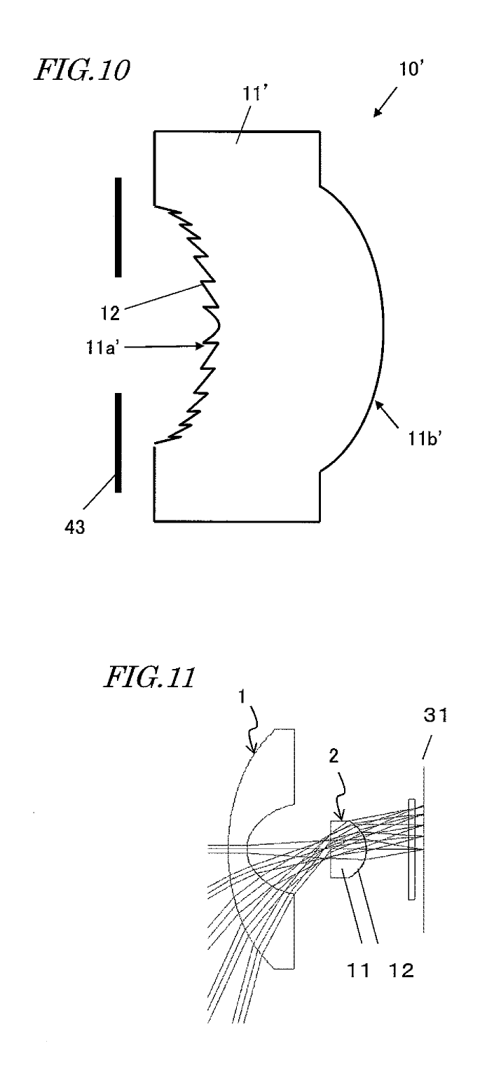

Also, in the imaging optical system of the preferred embodiment described above, the diffraction grating is arranged to face the image sensor. However, the diffraction grating may also be arranged to face the subject. FIG. 10 is a schematic cross-sectional view illustrating such an alternative preferred embodiment of an imaging optical system according to the present invention.

The imaging optical system shown in FIG. 10 includes a lens 10′, which includes a lens body 11′ with first and second surfaces 11a′ and 11b′ and a diffraction grating 12 that has been formed on the first surface 11a′. Also, the first surface 11a′ has a concave aspheric shape, while the second surface 11b′ has a convex aspheric shape. The lens 10′ satisfies the Inequality (6) and preferably satisfies the Inequality (7), too.

In the imaging optical system shown in FIG. 10, a light ray that has come from the subject passes through a diaphragm 43, enters the lens 10′ through the first surface 11a′ with the diffraction grating, and then gets diffracted by the second surface 11b′. The diffracted light goes out of the lens through the second surface 11b′ and then is sensed by an image sensor (not shown), for example. Since its lens satisfies the Inequality (6), the imaging optical system shown in FIG. 10 can also reduce the generation of fringed flare light rays and realizes good chromatic aberration properties.

### Examples

In the specific example of the present invention to be described below, it will be described how to set the upper- and lower-limit values of Inequalities (6) and (7).

FIG. 11 is a cross-sectional view illustrating a specific example of an imaging optical system according to the present invention. In this specific example, the imaging optical system includes first and second lenses 1 and 2, which are used as a set of two lenses. A diffraction grating 12 has been formed on the second surface of the second lens 2. The lens body 11 of the second lens 2 is made of a resin material, of which the main ingredient is polycarbonate, and has a d-line refractive index of 1.585 and a d-line Abbe number of 28. Although the lens body 11 is made of polycarbonate in this specific example, any other material may also be used as long as it has the predetermined refractive index. For example, the lens body 11 may also be made of polyethylene or polystyrene.

The following Table 1 summarizes the numerical data of the imaging optical system of this specific example. In the following data, ω represents the maximum angle of view (half angle of view), Fno represents an F number at the maximum angle of view, D represents the diameter of an effective area, which is defined by a light ray with the maximum angle of view and which is measured on the surface with the diffraction grating, and [symbol] represents the average diffracting ring zone pitch in the effective area that is defined by a light ray with the maximum angle of view and that is measured on the surface with the diffraction grating:

TABLE 1

| ω | 75 | degrees |
|---|---|---|
| Fno | 3.9 | |
| wavelength range used by imaging optical | 400 nm to 700 nm | |
| system | | |
| Depth of diffraction grating | 0.9 | μm |
| F number of axial bundle of rays | 2.8 | |
| Lens body's Abbe number | 27.9 | |
| D | 774 | μm |
| Λ | 36 | μm |

| | |
|---|---|
| Λ/(D × Fno) | 0.012 |
| Upper limit of Inequality (6) | 0.024 |
| Upper limit of Inequality (7) | 0.016 |

FIG. 12(a) shows a two-dimensional image that was produced on a focal plane when a planar wave with a wavelength of 550 nm was incident on an imaging optical system representing a specific example of the present invention from a direction with the maximum angle of view. FIG. 12(b) shows a two-dimensional image that was produced on a focal plane when a planar wave with a wavelength of 550 nm was incident on an imaging optical system representing a comparative example from a direction with the maximum angle of view. As the comparative example, a diffraction grating lens, of which the average diffracting ring zone pitch at the maximum angle of view was 18 μm, which was a half as large as in the specific example of the present invention, was used. In FIG. 12(a), the fringed flare light rays were concentrated around the center and the quantity of flare light rays could be reduced in the peripheral portion. In the comparative example, on the other hand, the diffracting ring zone pitch was so narrow that a greater quantity of fringed flare light rays spread more broadly. These results reveal that by setting [symbol] so as to satisfy Inequalities (6) and (7), the fringed flare light rays could be concentrated around the center and the quantity of the flare light rays could be reduced in the peripheral portion in the specific example of the present invention.

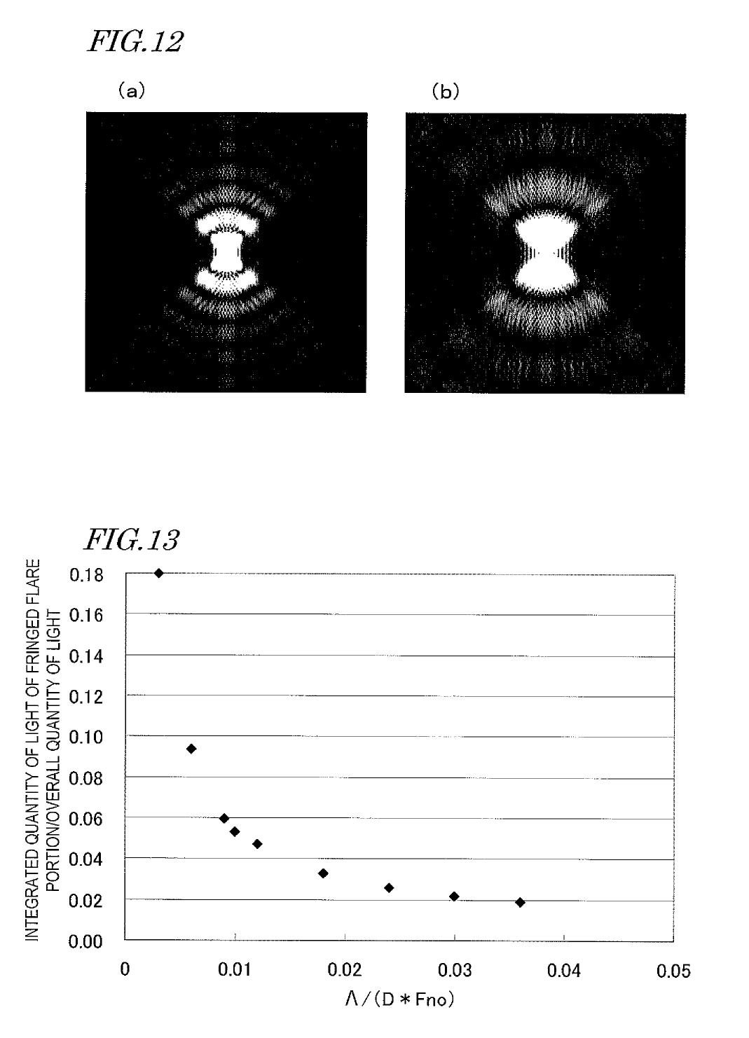

FIG. 13 is a graph showing how the quantity of the fringed flares produced changes with the diffracting ring zone pitch [symbol] . In FIG. 13, the abscissa represents the value of the conditional equation [symbol] /(D×Fno), while the ordinate represents an integrated quantity of light of fringed flare portion/overall quantity of light, which is the ratio of the integrated quantity of light of a flare portion to the overall integrated quantity of light of a two-dimensional image on a focal plane. In this case, the “flare portion” refers to eight areas that surround the central area in a situation where a two-dimensional image area is divided into nine (=3×3) areas. As can be seen from FIG. 13, the broader the average diffracting ring zone pitch, the smaller the integrated quantity of light of fringed flare portion/overall quantity of light (i.e., the more significantly the quantity of fringed flares produced can be reduced).

The diffracting ring zone pitch [symbol] can be changed by finely adjusting the power of the diffraction grating (i.e., the power of condensing incoming light by diffraction). More specifically, by decreasing the ratio of the power of diffraction to the overall power of the imaging optical system, the diffracting ring zone pitch [symbol] can be broadened. The broader the diffracting ring zone pitch [symbol] , the more significantly the quantity of fringed flares produced can be reduced. However, if the diffracting ring zone pitch [symbol] were too broadened, the power of diffraction would be too low to make a chromatic aberration correction sufficiently. For that reason, there is an upper limit to the diffracting ring zone pitch [symbol] . And that upper limit value determines the upper limit value of the conditional equation [symbol] /(D×Fno). Hereinafter, the upper limit value of the conditional equation [symbol] /(D×Fno) will be described.

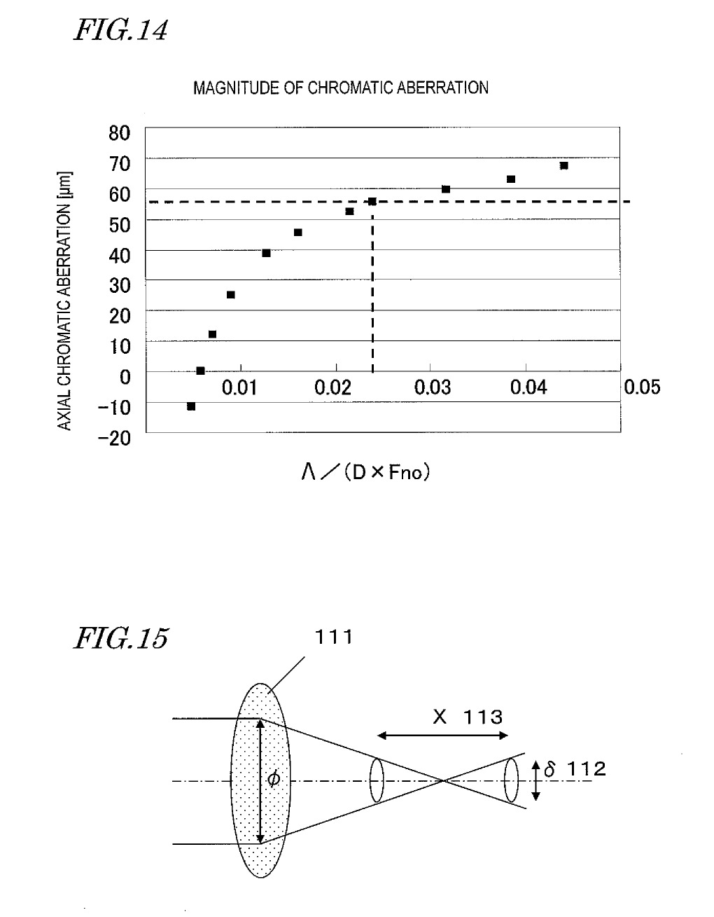

FIG. 14 is a graph showing how the magnitude of chromatic aberration changed in the imaging optical system of this specific example of the present invention when the diffracting ring zone pitch was adjusted by changing the phase polynomial of the diffraction grating. In FIG. 14, the abscissa represents the value of the conditional equation [symbol] /(D×Fno), while the ordinate represents the magnitude of axial chromatic aberration. The axial chromatic aberration represents a difference in focus position in the optical axis direction when a light ray with an R wavelength (640 nm) and a light ray with a B wavelength (440 nm) were incident on the imaging optical system.

A range in which the axial chromatic aberration is unnoticeable can be calculated by the following method. The F number of an axial bundle of rays satisfies F=f₀/φ, where f₀ represents the focal length and φ represents the entrance pupil diameter of the axial angle of view. If the depth of focus 113 of the lens shown in FIG. 15 is represented by x and the permissible circle of confusion 112 thereof is represented by δ, then φ/2: f₀=δ/2: x/2 should be satisfied considering the similarity between their triangles. Based on this equation, either f₀ or φ value is obtained and substituted into F=f₀/φ. And by solving this equation, the depth of focus 113 can be represented as 2F×δ. As an ordinary image capturing camera has a δ of 10 μm and its axial bundle of rays has an F number of 2.8, the depth of focus 113 becomes 56 μm. If the depth of focus 113 fails within this range, the axial chromatic aberration is unnoticeable. Thus, in the graph shown in FIG. 14, 0.024, which is the abscissa [symbol] /(D×Fno) associated with an axial chromatic aberration of 56 μm, is preferably set to be the upper limit value to the conditional equation [symbol] /(D×Fno). More preferably, 0.016, which is the abscissa associated with an axial chromatic aberration of 46 μm that is approximately 20% smaller than the previous value, is set to be the upper limit value to the conditional equation [symbol] /(D×Fno).

Next, let's consider how the upper limit value can be generalized. The larger the F number of an axial bundle of rays, the greater the depth of focus. Then, the upper limit to the conditional equation [symbol] /(D×Fno) can be increased. Also, the smaller the Abbe number of the lens material, the greater the degree of wavelength dispersion of the refractive indices. That is why the ratio of the power of diffraction to the overall power of the imaging optical system needs to be increased in that case. If the ratio of the power of diffraction to the overall power of the imaging optical system is increased, then the diffracting ring zone pitch [symbol] decreases. That is to say, the smaller the Abbe number, the narrower the average diffracting ring zone pitch, and therefore, the smaller the upper limit to the conditional equation [symbol] /(D×Fno). In this case, the difference in power of diffraction depending on the optical design is at most about ±5%, and therefore, does not have to be taken into account. The same can be said about a difference with the scale because if the scale changes, the permissible circle of confusion also changes.

In view of these considerations, the upper limit to the conditional equation [symbol] /(D×Fno) can be represented as:

(upper limit to conditional equation)=k·νd·F (11)

where νd is a d-line Abbe number of the material of the lens body and k is a constant. If 0.024 as the upper limit to the conditional equation [symbol] /(D×Fno), 27.9 as the d-line Abbe number of the material of the lens body, and 2.8 as the F number of the axial bundle of rays are substituted into this Equation (11) based on the results obtained in the specific example of the present invention described above, then the k value of the conditional equation [symbol] /(D×Fno) becomes 0.00031. Furthermore, if 0.016 is substituted as the upper limit to the conditional equation [symbol] /(D×Fno) into Equation (11), then the k value becomes 0.00021. Since this condition, i.e., the upper limit value to [symbol] /(D×Fno), is based on the supposition described above, this is a condition for minimizing the axial chromatic aberration in an imaging optical system including a lens that has a diffraction grating on only one of the two surfaces thereof.

It should be noted that the imaging optical system, of which the numerical data is shown in Table 1, was not designed so that its axial chromatic aberration would be the best value but was designed so that the axial chromatic aberration would fall within the range of the depth of focus. That is to say, the imaging optical system was designed so that the correction would be slightly incomplete. Specifically, although the average diffracting ring zone pitch [symbol] at the maximum angle of view, at which the axial chromatic aberration becomes the best value, is 18 μm, the average diffracting ring zone pitch [symbol] of the imaging optical system of this specific example was actually set to be 36 μm, which is twice as large as 18 μm.

As another method for broadening the diffracting ring zone pitch [symbol] a diffracted light ray of a higher order such as a second-order diffracted light ray or a third-order diffracted light ray may be used instead of the first-order diffracted light ray. In order to use a diffracted light ray of such a higher order, the phase polynomial of the diffraction grating may be the same as what is designed for a first-order diffracted light ray. But when the phase polynomial is transformed into a step shape, the diffracting ring zone pitch and the depth of the diffraction grating may be an integral number of times as large as in a situation where the first-order diffracted light ray is used. For example, when a second-order diffracted light ray is used, the diffracting ring zone pitch and the depth of the diffraction grating are twice as large as in a situation where the first-order diffracted light ray is used as shown in FIG. 16. In FIG. 16, the shape of the diffraction grating when the first-order diffracted light ray was used is indicated by the dotted line, while the shape of the diffraction grating when the second-order diffracted light ray was used is indicated by the solid line. As a result, the diffracting ring zone pitch can be broadened with the best axial chromatic aberration maintained. According to this method, however, the higher the order of the diffracted light ray used, the greater the optical path difference from the designed value due to the blazed thickness of the diffraction grating. As a result, a spherical aberration will be produced. For that reason, when a diffracted light ray of a higher order is used, the order of diffraction is preferably at most fourth order, at which the influence of the thickness is still relatively insignificant. When a fourth-order diffracted light ray is used, the average diffracting ring zone pitch at the maximum angle of view is 72 μm (=18 μm×4) and the upper limit value to the conditional equation [symbol] /(D×Fno) becomes 0.024 as in the example described above.

Next, the lower limit value to the conditional equation [symbol] /(D×Fno) will be described. If the average luminance per pixel in the central area (in a situation where the two-dimensional image area is divided into 3×3 areas) is standardized to be 255 (which is the maximum value of an image with 256 grayscales), the intensity of the fringed flares per pixel is preferably set to be two or less. When an image is shot using an ordinary camera, the shooting session is carried out so that the pixel luminance does not get saturated and a normal noise level becomes two or less. In this case, if the intensity of the fringed flares is two or less (i.e., if the SN ratio that is ratio of the fringed flare intensity to the noise is one or less), then the fringed flares can be hidden in the noise.

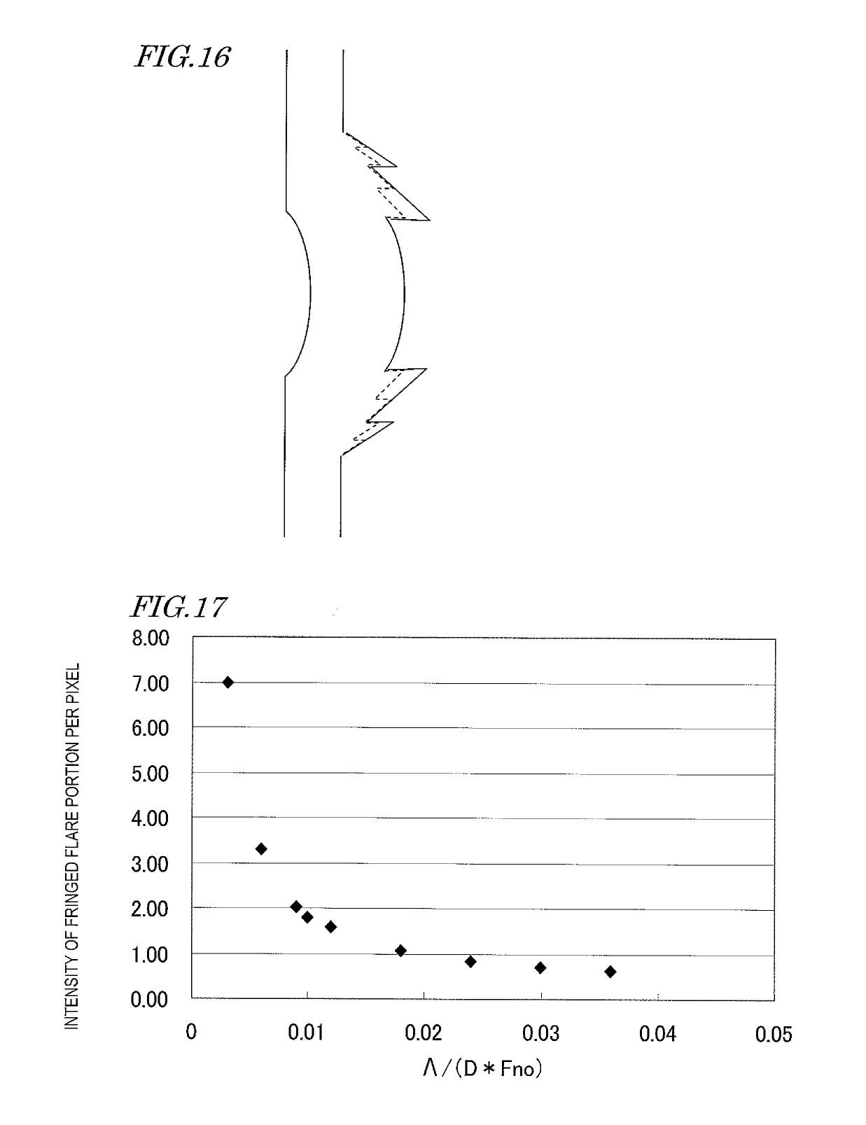

FIG. 17 is a graph showing how the intensity of a fringed flare portion per pixel changes with the value of the conditional equation [symbol] /(D×Fno). In FIG. 17, the abscissa represents the value of the conditional equation [symbol] /(D×Fno) and the ordinate represents the intensity of a fringed flare portion per pixel. As shown in FIG. 17, to reduce the intensity of the fringed flares to two or less (i.e., to reduce the SN ratio to one or less), the lower limit value to [symbol] /(D×Fno) is preferably set to be 0.008. Furthermore, to reduce the SN ratio to 0.9 or less, the lower limit value to [symbol] /(D×Fno) is more preferably set to be 0.01.

### INDUSTRIAL APPLICABILITY

An imaging optical system according to the present invention can be used particularly effectively as an imaging optical system for a camera of high quality.

### REFERENCE SIGNS LIST

1 first lens
2 second lens
11 lens body
12 diffraction grating
12a aspheric shape portion
13 optical axis
14 obliquely incident light
15 effective area
16 average diffracting ring zone pitch
21 diffracting ring zone
31 image sensor
41 exit pupil diameter
42 distance from exit pupil to imaging point
43 diaphragm
111 lens
112 permissible circle of confusion
113 depth of focus
201 first-order diffracted light ray
202 unnecessary order diffracted light ray
211 protective coating
212 diffraction grating lens
221 fringed flare light ray

1. An imaging optical system comprising a plurality of lenses which includes a lens that has first and second surfaces and that has a diffraction grating on only one of the first and second surfaces, the plurality of lenses being arranged in an optical axis direction,
wherein if the diameter of an effective area, which is defined by a light ray that has entered the lens with a maximum angle of view, is D when measured on the surface with the diffraction grating, an F number of the imaging optical system at the maximum angle of view is Fno, a d-line Abbe number of the lens is vd, and an F number of an axial bundle of rays is F, then the average diffracting ring zone pitch [symbol] of the effective area satisfies
$$0.008 \leq \frac{Λ}{D \times Fno} \leq 0.00031 \cdot vd \cdot F$$

2. The imaging optical system of claim 1, wherein the average diffracting ring zone pitch Λ satisfies
$$0.01 \leq \frac{Λ}{D \times Fno} \leq 0.00021 \cdot vd \cdot F$$

3. The imaging optical system of claim 2, wherein the order of diffraction of the diffraction grating is second-order or a higher order.

4. The imaging optical system of claim 3, further comprising an optical adjustment layer, which has been formed on the surface with the diffraction grating and which satisfies
$$\frac{0.9 m λ}{\vert {n}_{1} ( λ ) - {n}_{2} ( λ ) \vert} \leq d \leq \frac{1.1 m λ}{\vert {n}_{1} ( λ ) - {n}_{2} ( λ ) \vert}$$
where d is the depth of the diffraction grating, m is the order of diffraction, λ is the wavelength, n₁ (λ) is the refractive index of the lens at the wavelength λ, and n₂ (λ) is the refractive index of the optical adjustment layer at the wavelength λ.

5. The imaging optical system of claim 4, wherein if a light ray passes with a full angle of view through an area on the surface of the lens with the diffraction grating, the diffraction grating covers only a part of that area and does not cover the other part of that area.

6. The imaging optical system of claim 5, wherein if a light ray passes with the full angle of view through the area on the surface of the lens with the diffraction grating, the diffraction grating covers only a part of that area that is located closer to the optical axis of the lens than a predetermined radial location is, and does not cover the other part of that area that is located more distant from the optical axis than the predetermined radial location is.
